(19) United States
(12) Patent Application Publication
(10) Pub. No.: US 2012/0219733 A1
(43) Pub. Date: Aug. 30, 2012

(54) System and Method for Maintaining a Massage Device in a Localized Position

(76) Inventor: Brandon Waguespack, (US)

(21) Appl. No.: 13/035,498

(22) Filed: Feb. 25, 2011

(51) Int. Cl. B32B 1/02; B32B 7/12; B32B 3/10; C09J 7/02

(52) U.S. Cl. 428/34.1; 428/343; 428/198

(57) ABSTRACT

Described herein is an improved system and method for maintaining a massage device in a localized position wherein a massage device holder can comprise a containment unit comprising a front end, back end, top, left side and right side. Said containment unit front end can comprise an aperture that allows access to a chamber within such containment unit. The method also comprise a left adhesive strip having a top side, a bottom side, a left side and a right side, said left adhesive right side connected to said containment unit. Additionally, the method can comprise a first adhesive connected to the left adhesive strip bottom side. Furthermore, the method can comprise a right adhesive strip having a top side, a bottom side, a left side and a right side, said right adhesive left side connected to said containment unit and a second adhesive connected to the right adhesive strip bottom side.

### BACKGROUND

This disclosure relates to a system and method for maintaining a massage device in a localized position.

Nowadays, people enjoy using massage devices. People often use such device for relaxation purposes and for stress relief. Usually, using a massage device necessitates the use of manually holding the device to a localized part on the human body. However, such action requires some strength to hold the device and as such, prevents the person from relaxing and enjoying the massage. Therefore, it would be advantageous to implement an improved system and method for maintaining a massage device in a localized position on the human body.

### SUMMARY

An improved system and method for maintaining a massage device in a localized position wherein a massage device holder comprise a containment unit comprising a front end, back end, top, left side and right side. The said containment unit front end can comprise an aperture that allows access to a chamber within such containment unit. The method also comprise a left adhesive strip having a top side, a bottom side, a left side and a right side, said left adhesive right side connected to said containment unit. Additionally, the method can comprise a first adhesive connected to the left adhesive strip bottom side. Furthermore, the method can comprise a right adhesive strip having a top side, a bottom side, a left side and a right side, said right adhesive left side connected to said containment unit and a second adhesive connected to the right adhesive strip bottom side.

Further, a flexible strip is disclosed. Specifically, the flexible strip, in one embodiment, can comprise a body, and a left and right user adhesive strip, each having a top and a bottom, attached to said body. In one embodiment, flexible strip can comprise a right user adhesive strip having a top and a bottom, a user adhesive connected to said left adhesive strip bottom and said right adhesive strip bottom. Furthermore, the method can also comprise a first left massage device adhesive strip having a top and a bottom, attached to said body. In another embodiment, the flexible strip can comprise a first right massage device adhesive strip having a top and a bottom, attached to said body; and a massage device adhesive attached to said first left massage device adhesive strip and said first right massage device adhesive strip.

In another embodiment, the massage device holder can comprise a first planar material comprising an upper surface and a lower surface, a left portion, a center portion, and a right portion, a top portion and a bottom portion. Further in such embodiment, the massage device holder can comprise a second planar material comprising an upper surface and a lower surface, a left portion, a center portion, and a right portion, and a top portion and a bottom portion. Additionally, the massage device holder can comprise a planar material adhesive that affixes said first planar material lower surface left portion to said second planar material upper surface left portion, and that affixes said first planar material lower surface right portion to said second planar material upper surface right portion; and a user adhesive attached to said second planar material planar lower surface.

Lastly, a massage device can comprise an upper surface and a lower surface that is substantially flat. The said massage device can also comprise a left wing defined by a left portion of said upper surface and a left portion of said lower surface. Furthermore, the massage device can comprise a right wing defined by a right portion of said upper surface and a right portion of said lower surface. In one embodiment, the massage device can comprise a component casing defined by a center portion of said upper surface and a center portion of said lower surface and a user adhesive connected to said lower surface.

### BRIEF DESCRIPTION OF THE DRAWINGS

FIG. 1A illustrates one embodiment of a massage device holder on a user.

FIG. 1B illustrates a close up view of such massage device holder.

FIG. 2A illustrates an unfolded massage device holder with a collapsed containment unit.

FIG. 2B illustrated a folded massage device holder with a collapsed containment unit.

FIG. 3A illustrates a massage device holder consisting essentially of a flexible strip.

FIG. 3B illustrates a massage device holder with a massage device.

FIG. 4A illustrates another embodiment of a massage device holder wherein the massage device holder can comprise an upper planar material and a lower planar material.

FIG. 4B illustrates an exploded view of a massage device holder.

FIG. 5A illustrates a top view of massage device capable of being affixed directly to user.

FIG. 5B illustrates lower surface of massage device capable of being affixed directly to a user.

### DETAILED DESCRIPTION

Described herein is an improved system and method for maintaining a massage device in a localized position. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

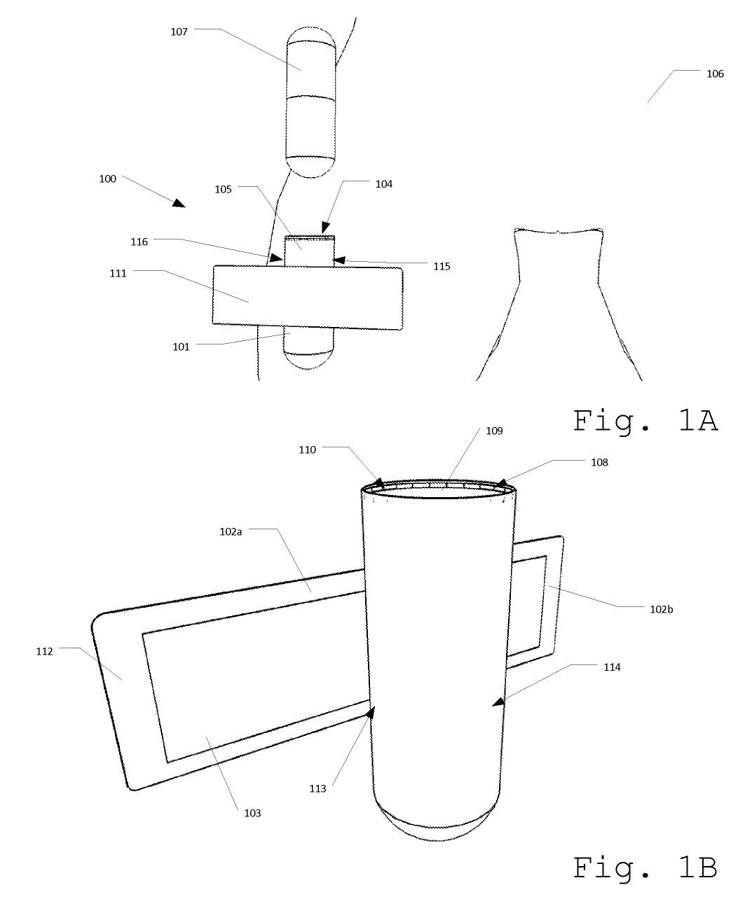

FIG. 1A illustrates a one embodiment of a massage device holder 100 on a user 106. FIG. 1B illustrates a close up view of such massage device holder 100. Massage device holder 100 can comprise materials such as cloth, plastic, rubber and/or foam. Massage device holder 100 can comprise a containment unit 101. In one embodiment, containment unit 101 can have an aperture 104 that gives access to a chamber 105. Chamber 105 can be substantially in the shape of a massage device 107. User 106 can place a massage device at least partially within chamber 105. In such embodiment, containment unit 101 can comprise a means of closing aperture 104. One means of closing aperture 104 can be a sealing adhesive 108 on an aperture inside lip 109. Examples of sealing adhesive 108 can include but are not limited to glue, hook-and-loop fasteners, and/or button fasteners. In one embodiment wherein sealing adhesive 108 is glue, by removing an adhesive material temporary cover 110 and pinching the open end, sealing adhesive 108 could trap massage device within containment unit 101. Another means of closing open end is a foldable flap at the open end of containment unit 101 with sealing adhesive 108 capable of sticking or otherwise connecting to a user and/or to massage device holder 100.

Massage device holder 100 can also comprise a left adhesive strip 102a, and a right adhesive strip 102b. Both adhesive strips 102 comprise a top surface 111 and a bottom surface 112. Bottom surface 112 can comprise a user adhesive 103, as shown in FIG. 1B. User adhesive 103 is an adhesive that is capable of temporarily affixing massage device holder 100 to user 106. An example of user adhesive 103 is glue or double-sided tape. In one embodiment left adhesive strip 102a and right adhesive strip 102b can be contiguous to form a single adhesive strip 102. In another embodiment, right adhesive strip 102a and left adhesive strip 102b can be separate. In one embodiment, left adhesive strip 102a and right adhesive strip 102b can connect to a bottom side 113 of containment unit 101. In another embodiment, left adhesive strip 102a and right adhesive strip 102b can connect to a top side of 114 of containment unit 101. In another embodiment, right adhesive strip 102a can connect to containment unit 101 on a right side 115 of containment unit 101 and left adhesive strip 102b can connect to containment unit 101 on a left side 116 of containment unit 101.

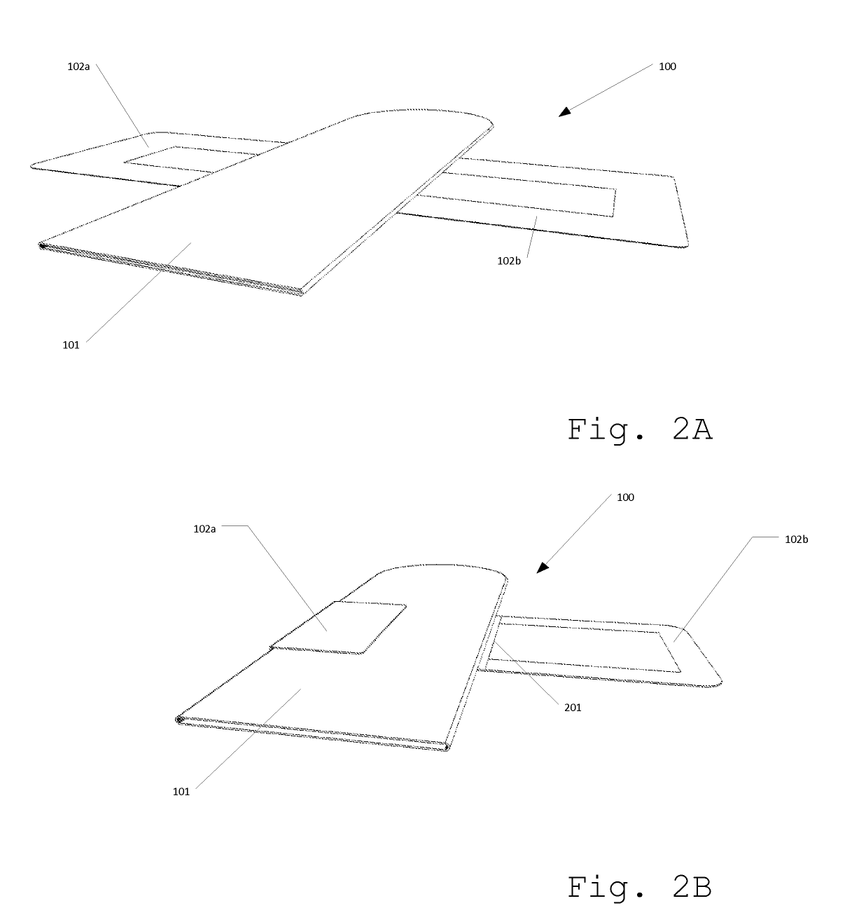

FIG. 2 illustrates one embodiment wherein massage device holder 100 can be collapsible for packaging. FIG. 2A illustrates an unfolded massage device holder 100 with a collapsed containment unit 101. FIG. 2B illustrates a folded massage device holder 100 with a collapsed containment unit 101. In one embodiment, left adhesive strip 102a and right adhesive strip 102b can extrude from containment unit 101. In such embodiment, left adhesive strip 102a and right adhesive strip 102b can each fold at or near a junction 201 between containment unit 101 and adhesive strips 102a and 102b respectively, to lay over containment unit 101, as shown in FIG. 2B. By collapsing and/or folding massage device holder 100, massage device holder can be easily packaged and sold individually or in packages comprising a plurality of massage device holders 100.

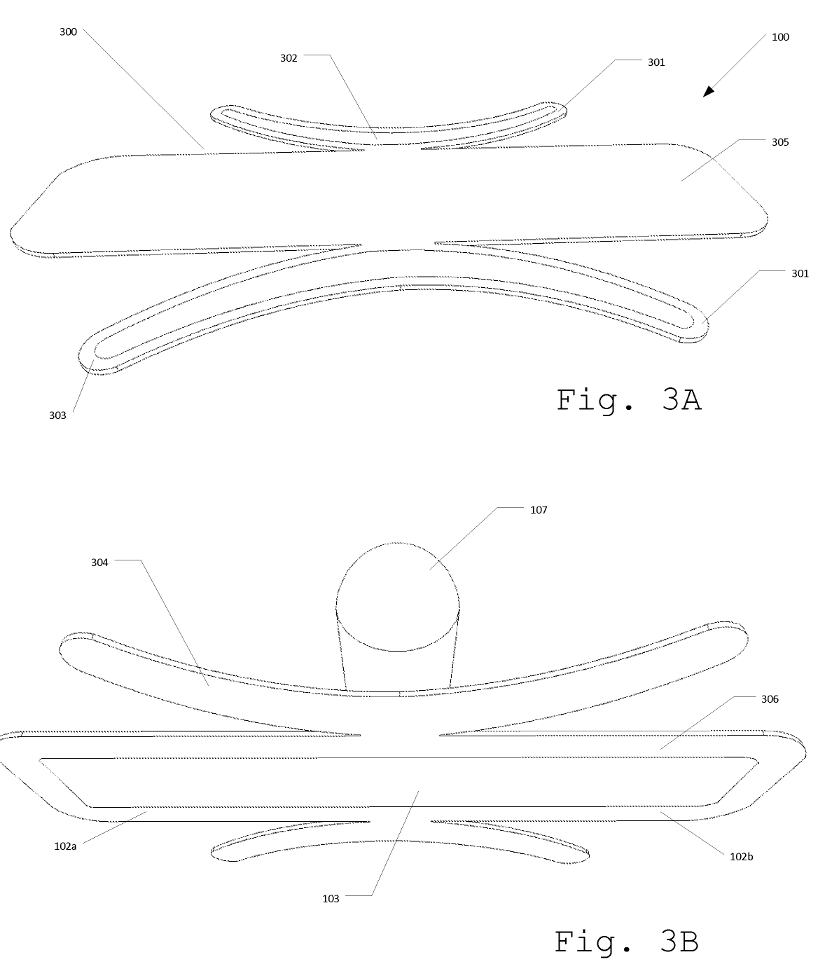

FIG. 3A illustrates a massage device holder 100 consisting essentially of a flexible strip 300. FIG. 3B illustrates a massage device holder 100 with massage device 107. In such embodiment, flexible strip 300 can comprise a plurality of massage device adhesive strips 301. Massage device adhesive strip 301 can comprise a massage device adhesive 302 such as glue, capable of connecting to massage device 107. In one embodiment, massage device adhesive 302 can reside on at least a portion of a massage device adhesive strip top 303. In such embodiment, massage device adhesive strips 301 can fold upwards to affix to and/or around massage device 107 positioned above flexible strip. In another embodiment, massage device adhesive 302 can reside on at least a portion of a massage device adhesive strip bottom 304, as shown in FIG. 3B. In such embodiment, massage device adhesive strips can fold downwards to affix to and or around massage device 107. Left adhesive strip 102a and right adhesive strip 102b can be an extrusion from flexible strip 300 bottom side 306 or top side 305 of adhesive strips 102a and 102b can be coated with user adhesive 103.

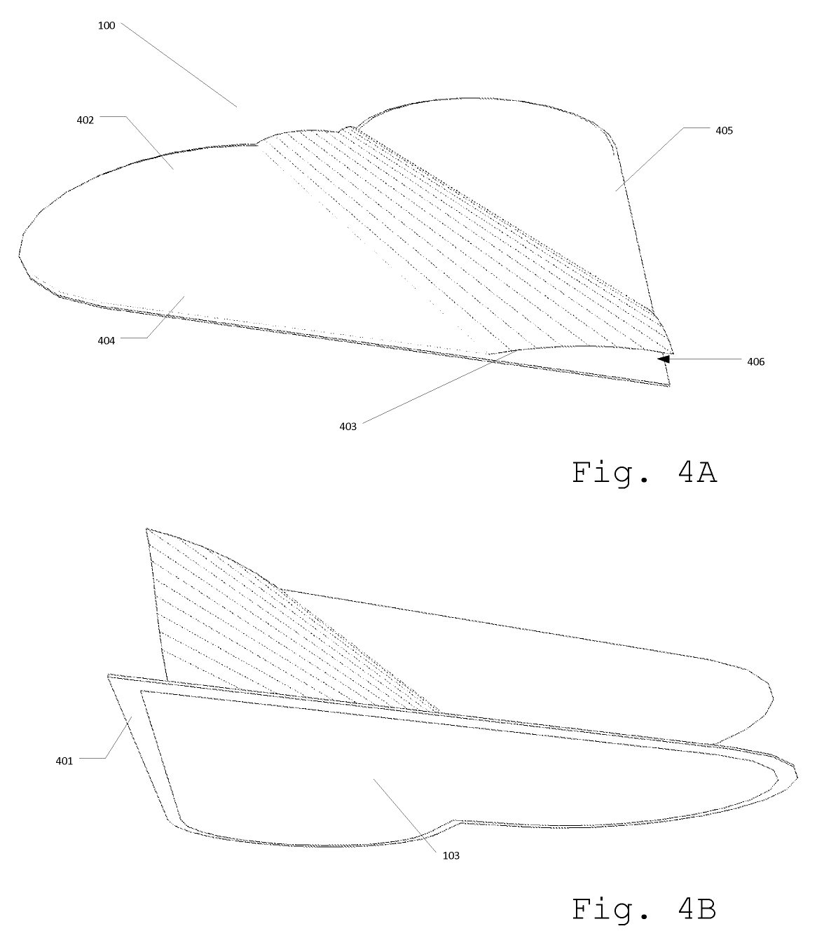

FIG. 4A illustrates another embodiment of massage device holder 100 wherein massage device holder 100 can comprise an upper planar material 402 and a lower planar material 401. FIG. 4B illustrates an exploded view of such massage device holder 100. In one embodiment, lower planar material 401 can be shaped similarly to upper planar material 402. Further in such embodiment, lower planar material 401 can be affixed with upper planar material 402 on a left side 404 and a right side 405 forming an aperture 406 capable of housing massage device 107. Further, user adhesive 103 can be attached to a bottom surface of lower planar material 401. In one embodiment, massage device holder 100 can be left opened at the top as shown in FIG. 4B, or closed to enclose massage device 107. Further in one embodiment, at least a portion of upper planner material 402 can comprise an elastic material capable of expanding around and grasping massage device when massage device 107 is within aperture 406 formed by upper planar material 402 and lower planer material 401. A bottom 403 can be either opened, as shown in FIG. 4A, or closed.

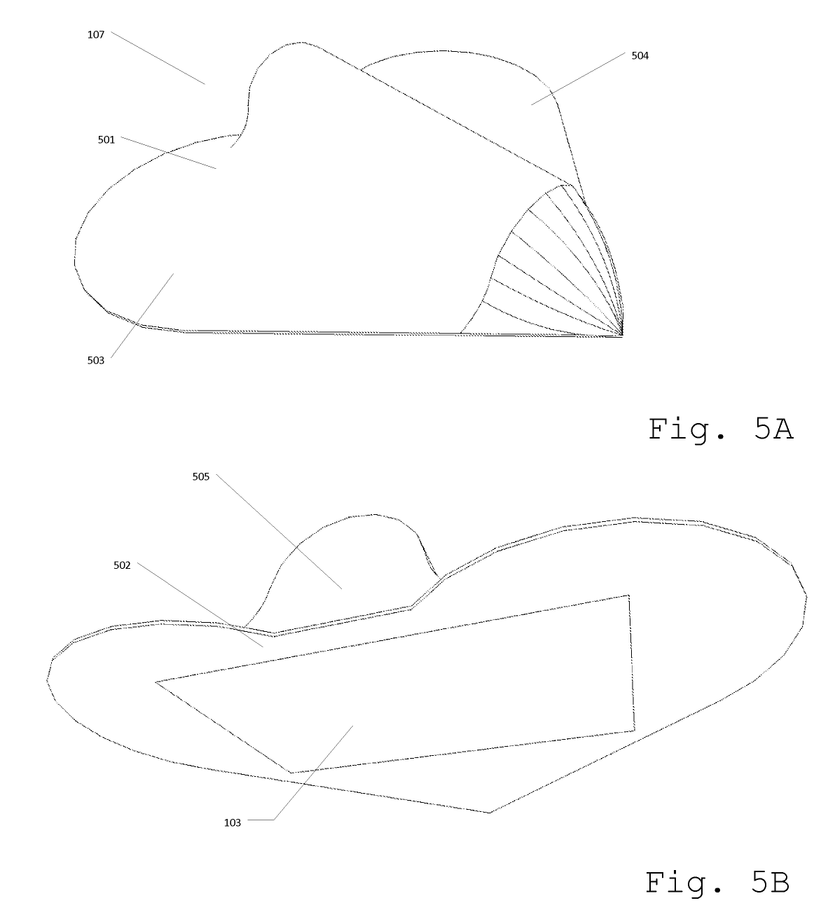

FIG. 5A illustrates a top view of massage device 107 capable of being affixed directly to user 106. FIG. 5B illustrates a bottom view of massage device 107 capable of being affixed directly to user 106. In one embodiment, massage device 107 can comprise an upper surface 501 and a lower surface 502. Such lower surface 502 can extend outward, creating a left wing 503 and a right wing 504. Lower surface 502 can be substantially flat. Between left wing 503 and right wing 504 is a massage component housing 505. In massage component housing houses typical massage device components such as a motor, wires, battery, and/or electronics related to the control of massage device 107. Left wing 503 and right wing 504 can be comprised of a flexible material such as thin plastic in one embodiment. Such constructions can help massage device 107 conform to the contours of user 106. User adhesive 103 can be attached to lower surface 502 to allow massage device 107 to stick to user 106. One benefit to massage device 107 as described in this paragraph and in FIG. 5 is that a solid-body constructions transfer's energy to user 106 efficiently. For purpose of this disclosure, solid body shall mean that left wing 502 and right wing 504 are formed together as one object.

Various changes in the details of the illustrated operational methods are possible without departing from the scope of the following claims. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A massage device holder comprising
a containment unit comprising a front end, back end, top, left side and right side, said containment unit front end comprising an aperture that allows access to a chamber within such containment unit;
a left adhesive strip having a top side, a bottom side, a left side and a right side, said left adhesive right side connected to said containment unit;
a first adhesive connected to the left adhesive strip bottom side;
a right adhesive strip having a top side, a bottom side, a left side and a right side, said right adhesive left side connected to said containment unit; and
a second adhesive connected to the right adhesive strip bottom side.

2. The massage device holder of claim 1 wherein such left adhesive strip connects to said containment unit at said containment unit top and such right adhesive strip connects to said containment unit at said containment unit top.

3. The massage device holder of claim 1 wherein such left adhesive strip connects to said containment unit at said containment unit bottom and such right adhesive strip connects to said containment unit at said containment unit bottom.

4. The massage device holder of claim 1 wherein said aperture comprises an inner lip, further wherein a sealer adhesive is affixed to said inner lip.

5. The massage device holder of claim 1 wherein said containment unit is collapsible.

6. The massage device holder of claim 1 wherein said left adhesive strip and right adhesive strip are foldable.

7. A flexible strip comprising
a body
a left user adhesive strip each having a top and a bottom, attached to said body;
a right user adhesive strip having a top and a bottom;
a user adhesive connected to said left adhesive strip bottom and said right adhesive strip bottom;
a first left massage device adhesive strip having a top and a bottom, attached to said body;
a first right massage device adhesive strip having a top and a bottom, attached to said body; and
a massage device adhesive attached to said first left massage device adhesive strip and said first right massage device adhesive strip.

8. The massage device holder of claim 7 wherein said massage device adhesive attaches to said left massage device adhesive strip bottom and said right massage device adhesive strip bottom.

9. The massage device holder of claim 7 wherein said massage device adhesive attaches to said left massage device adhesive strip top and said right massage device adhesive strip top.

10. The massage device holder of claim 7 further comprising
a second left massage device adhesive strip having a top and a bottom, attached to said body; and
a second right massage device adhesive strip having a top and a bottom, attached to said body.

11. The massage device holder comprising
a first planar material comprising an upper surface and a lower surface, a left portion, a center portion, and a right portion, a top portion and a bottom portion;
a second planar material comprising an upper surface and a lower surface, a left portion, a center portion, and a right portion, and a top portion and a bottom portion;
a planar material adhesive that affixes said first planar material lower surface left portion to said second planar material upper surface left portion, and that affixes said first planar material lower surface right portion to said second planar material upper surface right portion; and
a user adhesive attached to said second planar material planar lower surface.

12. The massage device holder of claim 11 wherein
said first planar material right side tapers toward said first planar material center;
said first planar material left side tapers toward said first planar material center;
said second planer material right side tapers toward said second planar material center; and
said second planar material left side tapers toward said second planar material center.

13. The massage device holder of claim 11 wherein said first planar material center comprises an elastic material.

14. The massage device holder of claim 13 wherein said second planar material comprises a rigid material.

15. The massage device holder of claim 11 wherein a first planar material center lower surface is connected to a second planar material center upper surface.

16. A massage device comprising
an upper surface;
a lower surface that is substantially flat;
a left wing defined by a left portion of said upper surface and a left portion of said lower surface
a right wing defined by a right portion of said upper surface and a right portion of said lower surface;
a component casing defined by a center portion of said upper surface and a center portion of said lower surface; and
a user adhesive connected to said lower surface.

17. The massage device of claim 16 wherein said component casing houses a motor.

18. The massage device of claim 16 wherein said left wing and said right wing comprises a flexible material.

19. The massage device of claim 16 wherein said user adhesive is a double-sided tape.

20. The massage device of claim 16 wherein said user adhesive is a glue.
